(19) United States
(12) Patent Application Publication
(10) Pub. No.: US 2006/0093181 A1
(43) Pub. Date: May 4, 2006

(54) Diaphragm for speaker device and speaker device including the diaphragm

(75) Inventors: Kenichi Kasahara, Tendo-shi (JP); Kyoichi Matsuda, Tendo-shi (JP)

Correspondence Address: NIXON & VANDERHYE, PC, 901 NORTH GLEBE ROAD, 11TH FLOOR, ARLINGTON, VA, 22203, US

(73) Assignees: PIONEER CORPORATION, Tokyo (JP); TOHOKU PIONEER CORPORATION, Tendo-shi (JP)

(21) Appl. No.: 11/260,481

(22) Filed: Oct. 28, 2005

(30) Foreign Application Priority Data
Oct. 28, 2004 (JP) 2004-314110

(51) Int. Cl. H04R 9/06

(52) U.S. Cl. 381/421

(57) ABSTRACT

A speaker device includes a vibration system having a voice coil bobbin, a diaphragm and a cap, and a magnetic circuit system. The diaphragm has a first fixing portion, a main cone portion, a second fixing portion, a drive cone portion and an opening. The first fixing portion is provided at the outer peripheral edge portion of the diaphragm to be fixed to an edge. The main cone portion formed into a parabolic shape is provided between the first fixing portion and the second fixing portion, i.e., in the vicinity of an outer peripheral portion of the drive cone portion. The second fixing portion is provided on a substantial border portion between the main cone portion and the drive cone portion, and the outer peripheral edge portion of the cap is mounted thereon. The drive cone portion formed into a curve or straight shape is provided between the second fixing portion and the opening. An inner peripheral edge portion of the drive cone portion is mounted onto an outer peripheral wall of the voice coil bobbin.

### BACKGROUND OF THE INVENTION

1. Field of the Invention

The present invention relates to a structure of a diaphragm for a speaker device.

2. Description of Related Art

Conventionally, there is known an external-magnet type speaker device including a vibration system having a cone-shape diaphragm, a voice coil bobbin and a center cap, and a magnetic circuit system having a yoke, a magnet and a plate. In such a speaker device, an inner peripheral portion of the cone-shape diaphragm is mounted on an outer peripheral wall of the voice coil bobbin, and an outer peripheral portion of the diaphragm is mounted onto the frame, for example. As the shape of the diaphragm, there are known a so-called straight shape having a straight cross-section, a parabolic shape or a paracurved shape having a curved cross-section like a bow. The speaker device including the diaphragm having a top portion in front of a mounting portion at inner and outer circumferences and formed into the paracurved shape curved like the bow is disclosed in Japanese Patent Application Laid-open under No. 11-313390, for example.

Generally, in the speaker device including the straight cone-shape diaphragm, high-frequency-band limit frequency Fh is high, and an unnecessary high-frequency component (peak) occurs thereabout. In addition, in the speaker device including the above-mentioned paracurved cone-shape diaphragm, the high-frequency-band limit frequency is further high, so the speaker device is not suitable for application for low-frequency reproduction such as a woofer and a sub woofer. On the contrary, in the speaker device including the parabolic cone-shape diaphragm, the high-frequency-band limit frequency is the lowest, but a larger peak of high-frequency component problematically occurs thereabout.

### SUMMARY OF THE INVENTION

The present invention has been achieved in order to solve the above problems. It is an object of this invention to provide a diaphragm for a speaker device and a speaker device thereof capable of lowering high-frequency-band limit frequency Fh and suppressing occurrence of an unnecessary high-frequency component (peak) thereabout.

According to one aspect of the present invention, there is provided a diaphragm for a speaker device including: a drive diaphragm portion which is bonded to a voice coil bobbin; a main diaphragm portion which is provided at an outer circumference of the drive diaphragm portion; and a cap which has an outer peripheral edge portion fixed to a substantial border portion of the drive diaphragm portion and the main diaphragm portion.

The above-mentioned diaphragm for the speaker device includes the drive diaphragm portion, the main diaphragm portion and the cap, and the outer peripheral edge portion of the cap is fixed to the border portion of the drive diaphragm portion and the main diaphragm portion. Thereby, the above-mentioned speaker device has a sound characteristic defined by a combination of the drive diaphragm portion and the main diaphragm portion. Therefore, by appropriately setting the shapes of the drive diaphragm portion and the main diaphragm portion, the high-frequency-band limit frequency Fh can be lowered, and it can be suppressed that the unnecessary high-frequency component (peak) occurs thereabout.

In a preferred example, the drive diaphragm portion may be formed into a curve shape or a straight shape having a center on a side opposite to a sound output side with respect to the drive diaphragm portion. In addition, the main diaphragm portion may be formed into a parabolic shape, particularly may be formed into a curve shape having a center on the sound output side of the drive diaphragm portion.

As the normal cone-shape diaphragm, there is known a cone-shape diaphragm having the parabolic shape, the straight shape or the paracurved shape. The speaker device to which the diaphragm formed into the parabolic shape is applied has such a characteristic that the high-frequency-band limit frequency Fh is low but the unnecessary high-frequency component (peak) occurs thereabout. The speaker device to which the diaphragm formed into the straight shape is applied has such a characteristic that the peak occurring around the high-frequency-band limit frequency Fh is small compared with the diaphragm formed into the parabolic shape. On the contrary, the speaker device to which the diaphragm formed into the paracurved shape is applied has such a characteristic that a flat characteristic can be advantageously obtained even around the high-frequency-band limit frequency Fh but the high-frequency-band limit frequency Fh problematically becomes high accordingly.

Therefore, the above-mentioned diaphragm for the speaker device has a structure as follows: the side of the inner peripheral portion is the drive diaphragm portion formed into the paracurved shape or the straight shape; the side of the outer peripheral portion is the main diaphragm portion formed into the parabolic shape; and the cap is mounted on the substantial border portion between the drive diaphragm portion and the main diaphragm portion. Thereby, it becomes possible to obtain the sound characteristic in which the paracurved shape or the straight shape and the parabolic shape are combined. Namely, by the combination of such a characteristic of the parabolic shape that the high-frequency-band limit frequency is low and such a characteristic of the paracurved shape or the straight shape that the peak around the high-frequency-band limit frequency is small, the high-frequency-band limit frequency Fh can be lowered, and it can be suppressed that the unnecessary high-frequency component (peak) occurs thereabout.

In a form of the above diaphragm for the speaker device, plural recessed portions or projecting portions may be formed on the main diaphragm portion. Thereby, the strength of the diaphragm for the speaker device can be improved. In addition, the speaker device including the above diaphragm for the speaker device can be configured.

The nature, utility, and further features of this invention will be more clearly apparent from the following detailed description with respect to preferred embodiment of the invention when read in conjunction with the accompanying drawings briefly described below.

### BRIEF DESCRIPTION OF THE DRAWINGS

FIG. 1 shows a cross-sectional view of a speaker device according to an embodiment of the present invention;

FIGS. 2A and 2B are a plan view and a cross-sectional view showing a structure of a diaphragm according to this embodiment;

FIG. 3 is a partly cross-sectional view showing a mounting structure of the diaphragm according to this embodiment and other components;

FIG. 4 is a graph showing a sound characteristic of the speaker device having the diaphragm according to this embodiment;

FIG. 5 is a partly cross-sectional view showing a mounting structure of a diaphragm according to a comparative example and other components;

FIG. 6 is a graph showing a sound characteristic of the speaker device having the diaphragm according to the comparative example;

FIGS. 7A to 7C show structures of cone-shape diaphragms having various kinds of shapes, and FIG. 7D is a graph showing sound characteristics thereof; and

FIGS. 8A and 8B are a plan view and a cross-sectional view showing a structure of a diaphragm according to a modification.

### DETAILED DESCRIPTION OF THE PREFERRED EMBODIMENTS

The preferred embodiments of the present invention will now be described below with reference to the attached drawings. In this embodiment, the diaphragm has a predetermined structure which lowers the high-frequency-band limit frequency Fh and suppresses the occurrence of the unnecessary high-frequency component (peak) thereabout.

[Configuration of Speaker Device]

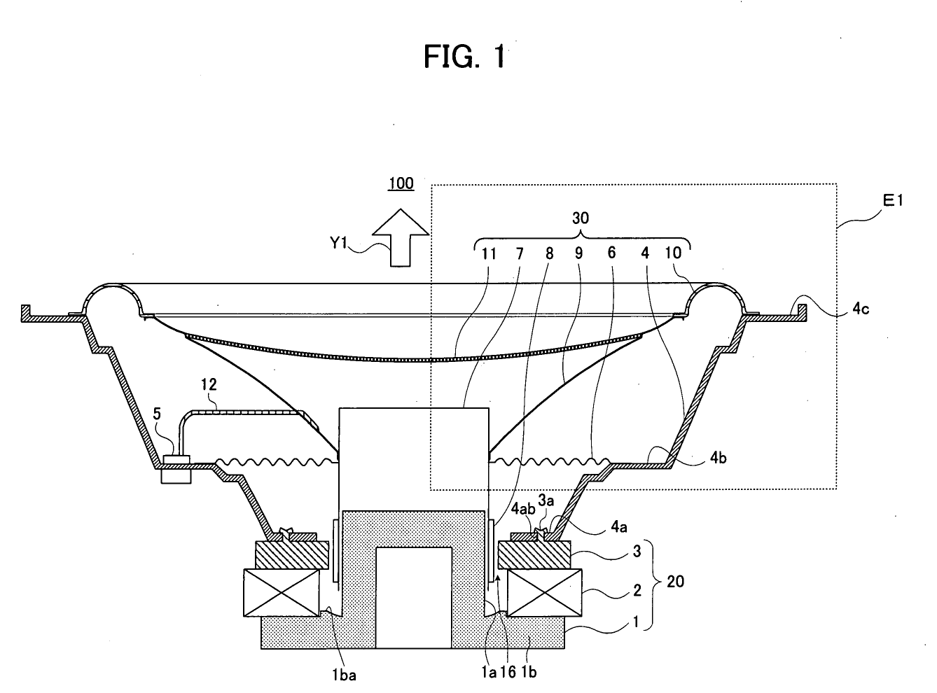

FIG. 1 schematically shows a configuration of a speaker device 100 according to an embodiment of the present invention. The speaker device 100 can be preferably used as an on-vehicle speaker. FIG. 1 shows a cross-sectional view when cutting the speaker device 100 by a plane including a central axis thereof. The description will be given of the configuration of the speaker device 100, below.

As shown in FIG. 1, the speaker device 100 mainly includes a magnetic circuit system 20 having a yoke 1, a magnet 2 and a plate 3, a vibration system 30 having a frame 4, a damper 6, a voice coil bobbin 7, a voice coil 8, a diaphragm 9, an edge 10 and a cap 11, and plural terminal members 5 and plural tinsel cords 12 as various kinds of members.

First, the description will be given of respective components of the magnetic circuit system 20.

The magnetic circuit system 20 is configured as an external-magnet type magnetic circuit. The yoke 1 has a cylindrical pole portion 1a and a flange portion 1b extending in an outward direction from a lower end portion of an outer peripheral wall thereof. On the upper surface of the inner peripheral portion of the flange portion 1b, a projecting portion 1ba is formed. The projecting portion 1ba has a function of positioning the magnet 2 at an appropriate position on the flange portion 1b. The annular magnet 2 is positioned at the appropriate position onto an upper surface of the flange portion 1b by the projecting portion 1ba of the yoke 1 to be fixed onto the flange portion 1b. The annular plate 3 is fixed onto the annular magnet 2. In addition, on the upper surface of the annular plate 3, plural projecting portions 3a are formed. Each of the projecting portions 3a is formed in the direction of the circumference of the annular plate 3 with an appropriate space. Each of the plural projecting portions 3a has a function of positioning and holding a first flat portion 4a of the frame 4 at an appropriate position on the annular plate 3. In the magnetic circuit system 20, the magnetic circuit is constructed by the magnet 2 and the plate 3, and magnetic flux of the magnet 2 concentrates on a magnetic gap 16 formed between an inner peripheral wall of the plate 3 and an outer peripheral wall of the pole portion 1a.

Next, the description will be given of respective components of the vibration system 30.

The various components of the speaker device 100 are fixed onto the frame 4, and the frame 4 serves as supporting member of the components. The frame 4 has the first flat portion 4a, a second flat portion 4b and a third flat portion 4c, whose upper surfaces ensure flatness. The first flat portion 4a has plural openings 4ab in the direction of the circumference with an appropriate space, and it is formed at a lower position of the frame 4. Each of the correspondent projecting portions 3a of the plate 3 is inserted into each of the openings 4ab, and each upper portion of the projecting portions 3a is caulked. Thereby, the first flat portion 4a is positioned at the appropriate position on the annular plate 3 to be fixed onto the annular plate 3. The second flat portion 4b is formed at a substantial middle position of the frame 4. Onto an upper surface of the second flat portion 4b, the outer peripheral edge portion of the damper 6 is fixed. The third flat portion 4c is formed at a position on an upper side of the frame 4. Onto an upper surface of the third flat portion 4c, the outer peripheral edge portion of the edge 10 is mounted.

The voice coil bobbin 7 is formed into a substantially cylindrical shape. The voice coil 8 is wound around the vicinity of the lower end portion of the outer peripheral wall of the voice coil bobbin 7. The vicinity of the lower end portion of the outer peripheral wall of the voice coil bobbin 7 is opposite to each of the inner peripheral walls of the annular magnet 2 and plate 3 with a constant space therebetween. On the other hand, the vicinity of the lower end portion of the inner peripheral wall of the voice coil bobbin 7 is opposite to the outer peripheral wall of the pole portion 1a serving as a component of the yoke 1 with a constant space. A gap (magnetic gap 16) is formed between the outer peripheral wall of the pole portion 1a and the inner peripheral wall of the plate 3.

The voice coil 8 has a pair of positive/negative lead wires (not shown). A lead wire at the positive side is an input wiring for an L (or R) channel signal, and a lead wire at the negative side is an input wiring for a ground (GND: ground) signal. Each of the lead wires is electrically connected to one end of each of tinsel cords 12 drawn to a front side (sound output side) of the diaphragm 9, and other end of each of the tinsel cords 12 is electrically connected to one end of each terminal member 5 mounted onto the upper surface of the second flat portion 4b of the frame 4. On the other hand, the other end of each terminal member 5 is electrically connected to each input wiring of the amplifier. Therefore, the electric signal of one channel is inputted to the voice coil 8 from the amplifier via each of terminal members 5, each of the tinsel cords 12 and each of the lead wires.

The damper 6 is formed into an annular shape, and has an elastic portion formed with concentric corrugations. The outer peripheral edge portion of the damper 6 is fixed onto the second flat portion 4b of the frame 4, and the inner peripheral edge portion of the damper 6 is fixed to the outer peripheral wall of the voice coil bobbin 7.

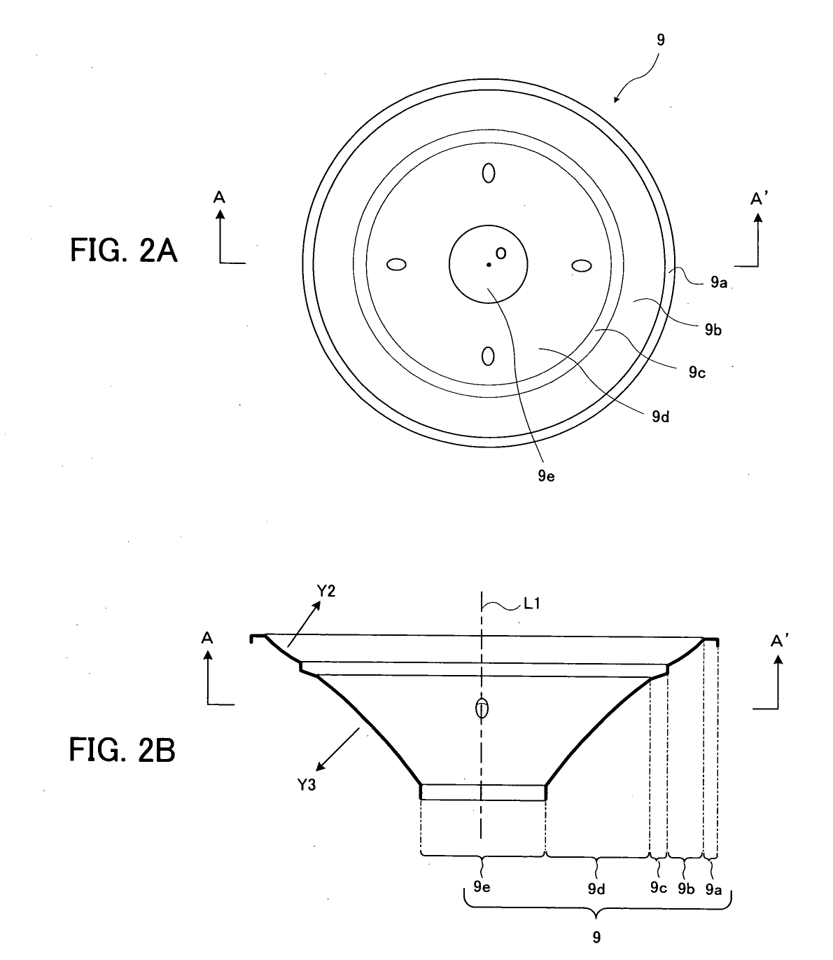

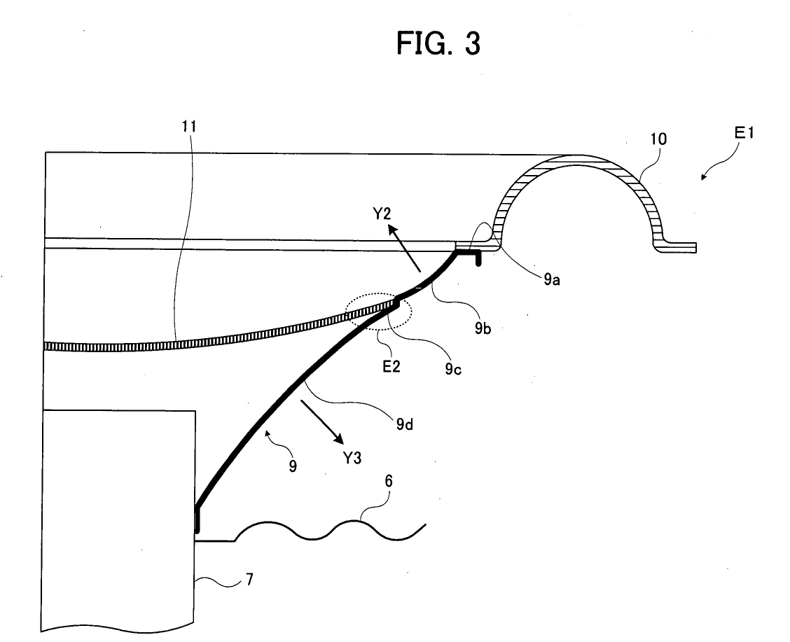

Various kinds of materials such as paper, high polymer and metal can be applied to the diaphragm 9 in accordance with the various use purposes. FIGS. 2A and 2B show the structure of the diaphragm 9 being the characteristic of the present invention. FIG. 2A shows a plan view of the diaphragm 9 observed in the direction opposite to an arrow Y1 from the upper portion of FIG. 1. FIG. 2B shows a cross-sectional view of the diaphragm 9 taken along a cut line A-A′ including a central point 0 in FIG. 2A. In FIG. 2B, a central axis L1 is a straight line including the central point 0 of the diaphragm 9. In addition, FIG. 3 shows a partly cross-sectional view corresponding to a broken line area E1 shown in FIG. 1. In FIG. 3, an illustration of the frame 4 is omitted for convenience.

As shown in FIGS. 2A and 2B, the diaphragm 9 is formed into the so-called cone shape. The diaphragm 9 has a first fixing portion 9a, a main diaphragm portion 9b (hereinafter referred to as “main cone portion 9b”), a second fixing portion 9c, a drive diaphragm portion 9d (hereinafter referred to as “drive cone portion 9d”) and an opening 9e, which are integrally formed.

The first fixing portion 9a is positioned at the outer peripheral edge portion of the diaphragm 9. As shown in FIG. 3, the inner peripheral edge portion of the edge 10 is fixed onto the first fixing portion 9a.

The main cone portion 9b is positioned between the first fixing portion 9a and the second fixing portion 9c. That is, the main cone portion 9b is provided in the outer circumference of the drive cone portion 9d. As shown in FIGS. 2A and 2B and FIG. 3, the main cone portion 9b has the cross-section formed into the curve shape, whose central point is positioned in the direction of an arrow Y2, i.e., on the sound output side of the diaphragm 9. Therefore, the main cone portion 9b is formed into the so-called parabolic shape.

As shown in a broken line area E2, the second fixing portion 9c is positioned at a substantial border of the main cone portion 9b and the drive cone portion 9d. In addition, the second fixing portion 9c serves as a transition portion (changing portion) at which the main cone portion 9b and the drive cone portion 9d are connected. As shown in FIG. 3, the outer peripheral edge portion of the cap 11 is mounted onto the second fixing portion 9c. Therefore, the second fixing portion 9c has a function of supporting the cap 11.

The drive cone portion 9d is positioned between the second fixing potion 9c and the opening 9e. As shown in FIGS. 2A and 2B and FIG. 3, the drive cone portion 9d is formed into the curve shape, whose central point is positioned in the direction of an arrow Y3, i.e., on the side opposite to the sound output side with respect to the diaphragm 9. Thus, the drive cone portion 9d is formed into the so-called paracurved shape (also simply referred to as “curved shape”). The inner peripheral edge portion of the drive cone portion 9d is bonded to the outer peripheral wall of the voice coil bobbin 7.

The opening 9e is formed at the inner peripheral portion of the drive cone portion 9d. The opening 9e is formed slightly larger than the outer diameter of the voice coil bobbin 7, and as shown in FIG. 3, the voice coil bobbin 7 is inserted into the opening 9e.

The diaphragm 9 having the above-mentioned structure particularly has such a characteristic that the main cone portion 9b and the drive cone portion 9d are formed on the outer side and on the inner side, respectively, with respect to the second fixing portion 9c. As shown in FIG. 1 and FIG. 3, the inner peripheral edge portion of the diaphragm 9 is mounted onto the area in the vicinity of the inner peripheral edge portion of the damper 6 and in the vicinity of the upper end of the outer peripheral wall of the voice coil bobbin 7.

The edge 10 has the cross-section substantially formed into a half circle. The inner peripheral edge portion of the edge 10 is fixed onto the first fixing portion 9a of the diaphragm 9, and the outer peripheral edge portion of the edge 10 is fixed onto the third flat portion 4c of the frame 4.

The cap 11 is formed into the substantial circle-shape (not shown) when planarly observed, and is formed into a curve shape projecting on the upper surface side of the voice coil bobbin 7 when cross-sectionally observed. As shown in FIG. 1 and FIG. 3, the outer peripheral edge portion of the cap 11 is mounted onto the second fixing portion 9c of the diaphragm 9 via an adhesive. Therefore, the drive cone portion 9d of the diaphragm 9 and the upper surface of the voice coil bobbin 7 are covered with the cap 11, as shown in FIG. 1 and FIG. 3. Thereby, the cap 11 has a function of preventing dust and a foreign material from entering the speaker device 100.

In the above-mentioned speaker device 100, the electric signal outputted from the amplifier is outputted to the voice coil 8 via each of the terminal portions 5, each of the tinsel cords 15 and each lead wire. Thereby, driving force occurs to the voice coil 8 in the magnetic gap 16, and vibrates the diaphragm 9 in the axial direction of the speaker device 100. Thus, the speaker device 100 emits acoustic waves in the direction of the arrow Y1.

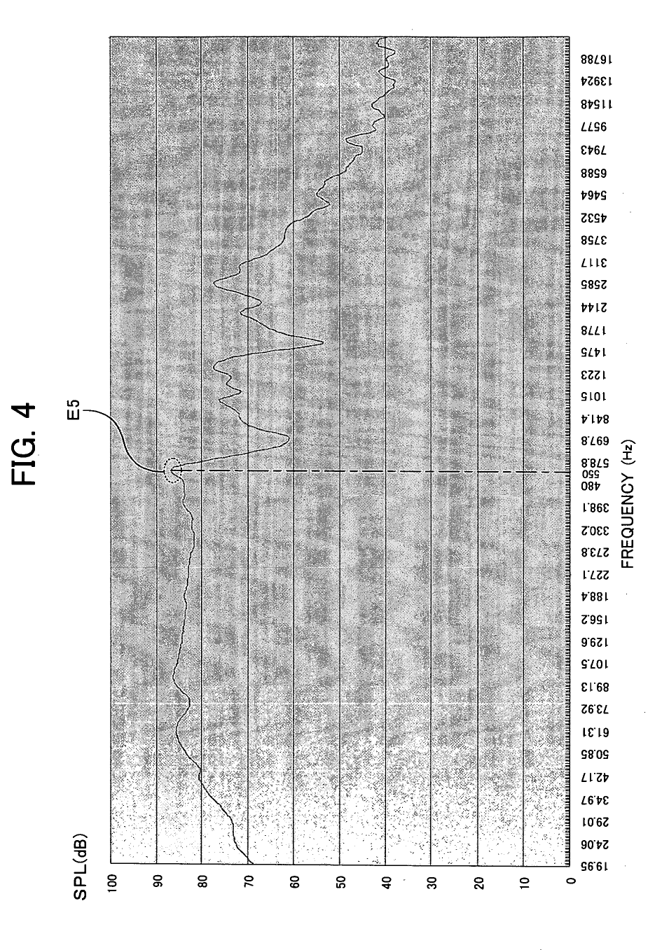

Next, with reference to FIG. 4, the description will be given of the sound characteristic of the speaker device 100 including the above-mentioned diaphragm 9 of the present invention. FIG. 4 is a graph showing a measured example of the sound characteristic of the speaker device 100. A vertical axis thereof indicates a sound pressure level (SPL: Sound Pressure Level), and a horizontal axis indicates frequency (Hz), respectively. As shown in FIG. 4, in the speaker device 100, the almost flat sound pressure level is obtained in the frequency band of about 60 Hz to about 550 Hz. The sound pressure level is about 82 (dB). Particularly, in the speaker device 100, the high-frequency-band limit frequency Fh is about 550 Hz, and the sound pressure level of the high-frequency-band limit frequency Fh is about 85 (dB). The high-frequency-band limit frequency Fh is the frequency at which the vibration of the voice coil bobbin 7 is not transmitted to the diaphragm 9.

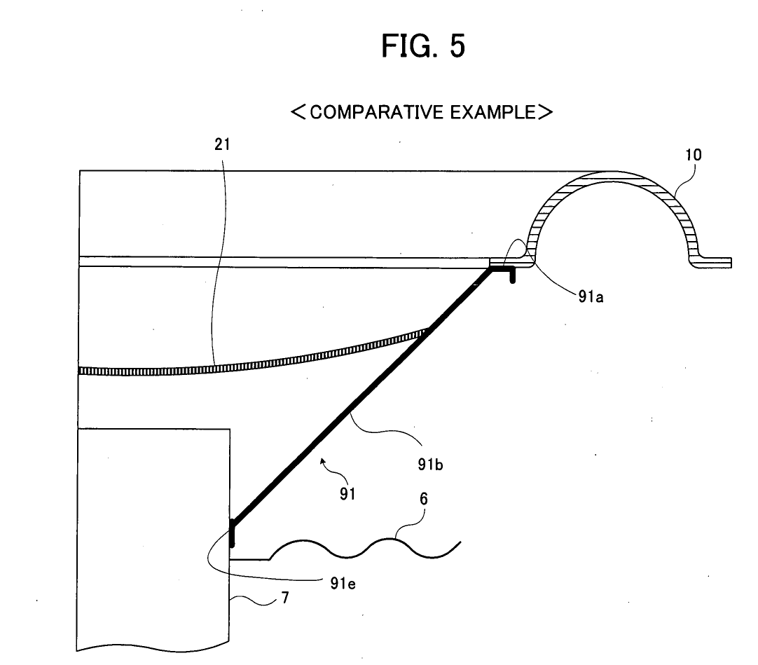

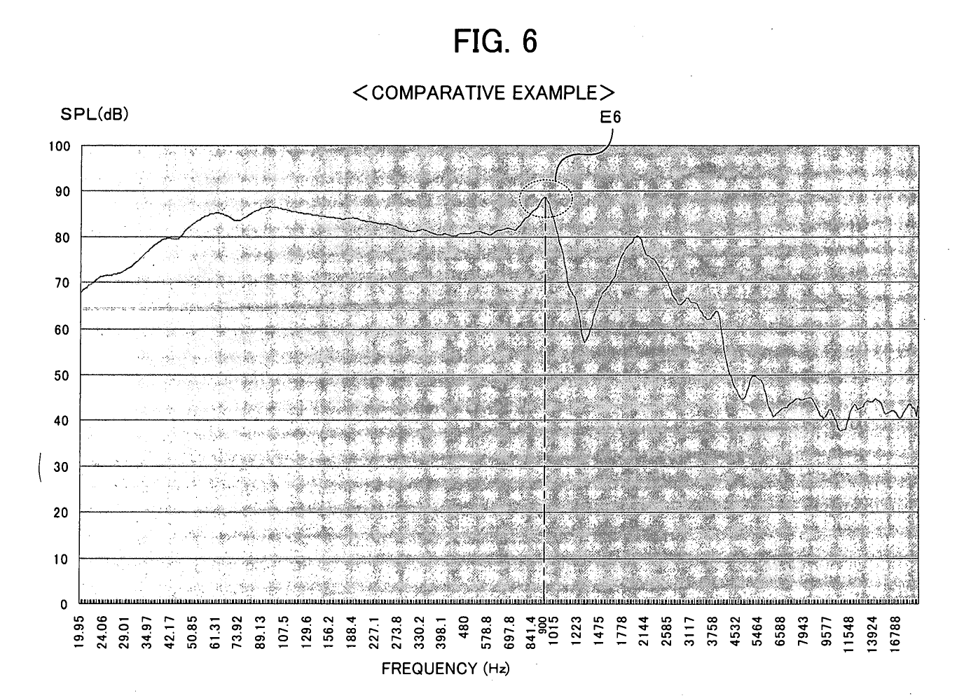

Next, the description will be given of characteristic operation and effect of the speaker device 100 including the diaphragm 9 of the present invention, compared with the speaker device according to the comparative example, with reference to FIG. 4 to FIG. 6. FIG. 5 shows a partly cross-sectional view of the speaker device of the comparative example. FIG. 6 shows a graph of the sound characteristic of the speaker device according to the comparative example. It is noted that the graph shown in FIG. 6 is measured on the same condition as the present invention.

First, the description will be given of the configuration of the speaker device according to the comparative example, with reference to FIG. 5. It is noted that the same reference numerals are given to the same components as those of the present invention, and explanations thereof are omitted, below.

As understood with reference to FIG. 3 and FIG. 5, when the speaker device according to the comparative example and the speaker device 100 of the present invention are compared, the shape of a diaphragm 91 is different from the diaphragm 9. As shown in FIG. 5, the diaphragm 91 is formed into the cone shape, and has a first fixing portion 91a, a straight cone portion 91b and an opening 91e. Namely, the diaphragm 91 according to the comparative example is formed into the so-called straight cone shape.

In the diaphragm 91 having the above-mentioned structure, the inner peripheral edge portion is mounted onto the area in the vicinity of the inner peripheral edge portion of the damper 6 and onto the outer peripheral wall of the voice coil bobbin 7. In addition, the inner peripheral edge portion of the edge 10 is mounted onto the first fixing portion 91a of the diaphragm 91, and the outer peripheral edge portion of a cap 21 is mounted onto the straight cone portion 91b of the diaphragm 91.

Next, the description will be given of the sound characteristic of the speaker device having the diaphragm 91 according to the comparative example, with reference to FIG. 6. FIG. 6 is the graph showing a measured example of the sound characteristic of the speaker device according to the comparative example. The vertical axis indicates the sound pressure level (SPL), and the horizontal axis indicates the frequency (Hz), respectively. As shown in FIG. 6, in the speaker device according to the comparative example, the almost flat sound pressure level is obtained in the frequency band between about 60 Hz and about 698 Hz. Similarly to the present invention, the sound pressure level is about 82 (dB). Particularly, in the speaker device according to the comparative example, the high-frequency-band limit frequency Fh is about 900 Hz, and the sound pressure level of the high-frequency-band limit frequency Fh is about 88 (dB), similarly to the present invention.

As mentioned above, the high-frequency-band limit frequency Fh of the speaker device according to the comparative example is about 900 Hz. On the contrary, the high-frequency-band limit frequency Fh of the speaker device 100 of the present invention is about 550 Hz. Therefore, the high-frequency-band limit frequency Fh of the speaker device 100 of the present invention is extremely lower than that of the comparative example. Additionally, in the comparative example and the present invention, as shown in a broken line area E6 shown in FIG. 6 and a broken line area E5 shown in FIG. 4, peaks of unnecessary high-frequency components occur around the respective high-frequency-band limit frequencies Fh. As understood by comparing the sizes of the respective peaks, the size of the peak of the unnecessary high-frequency component in the speaker device 100 of the present invention becomes smaller than the size of the peak in the comparative example. As described above, by applying the diaphragm 9 having the characteristic of the present invention to the speaker device, the high-frequency-band limit frequency Fh can be lowered, and it can be suppressed that the unnecessary high-frequency component (peak) occurs thereabout.

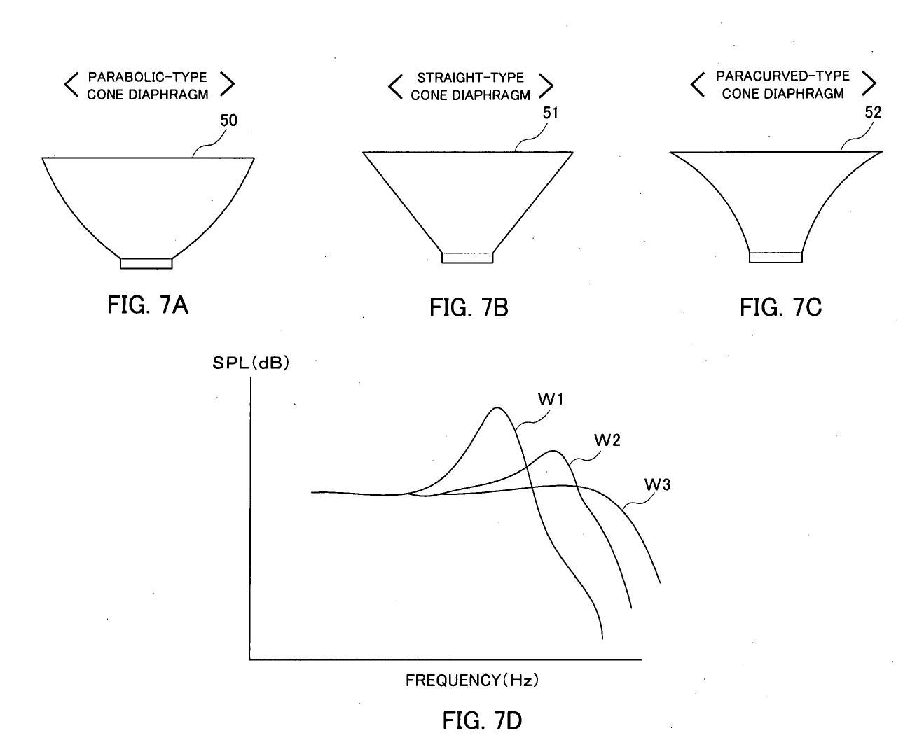

A reason thereof will be explained with reference to FIGS. 7A to 7D. FIGS. 7A, 7B and 7C show cross-sectional views of a parabolic-type cone diaphragm 50, a straight-type cone diaphragm 51 and a paracurved-type cone diaphragm 52, respectively, and they are generally known. FIG. 7D shows graphs showing measured examples of the sound characteristics of the speaker devices including the respective diaphragms. In FIG. 7D, graphs W1, W2 and W3 indicate the sound characteristics corresponding to the parabolic-type cone diaphragm 50, the straight-type cone diaphragm 51 and the paracurved-type cone diaphragm 52, respectively.

As understood with reference to the graphs W1 to W3 shown in FIG. 7D, in the speaker device including the parabolic-type cone diaphragm 50, the high-frequency-band limit frequency Fh is low. However, the diaphragm 50 has such a weak point that the large peak occurs around the high-frequency-band limit frequency Fh. Additionally, as for the straight-type cone diaphragm 51, the peak occurring around the high-frequency-band limit frequency Fh becomes smaller than the peak for the parabolic-type cone diaphragm 50. Moreover, in the speaker device including the paracurved-type cone diaphragm 52, the peak hardly occurs, and the flat sound characteristic can be obtained up to high frequency.

The diaphragm 9 of the present invention is structured to employ the advantages of the characteristics of the respective diaphragms. Namely, in the parabolic-type cone diaphragm 50, the high-frequency-band limit frequency Fh is low, but the peak occurring thereabout is large. On the contrary, in the paracurved-type cone diaphragm 52, the high-frequency-band limit frequency Fh is high, but the peak occurring thereabout is small. Therefore, as for the diaphragm 9 of the present invention, by combining both advantages of the diaphragms 50 and 52, the cone-shape diaphragm is structured. Namely, as for the diaphragm 9 of the present invention, the main cone portion 9b is formed into the parabolic shape, and the drive cone portion 9d is formed into the paracurved shape. Then, as described above, the outer peripheral edge portion of the cap 11 is mounted on the substantial border portion (the second fixing portion 9c) between the main cone portion 9b and the drive cone portion 9d. By such a structure, the high-frequency-band limit frequency Fh can be lowered, and it can be suppressed that the unnecessary high-frequency component (peak) occurs thereabout.

A speaker system generally includes a Low Pass Filter (LPF) between an amplifier or a head unit and a speaker device. Thereby, the electrical signal corresponding to the unnecessary high-frequency component inputted to the speaker device from the amplifier is cut. However, even if such an LPF is provided in the speaker system, it is impossible to remove the unnecessary high-frequency component occurring based on the shape of the diaphragm at the time of the driving of the speaker device. Namely, unless the shape of the diaphragm is contrived, it is impossible to remove the unnecessary high-frequency component (peak) occurring from the diaphragm. Thus, the above-mentioned structure of the diaphragm 9 is effective in removing the unnecessary high-frequency component (peak) occurring based on the shape of the diaphragm.

[Modification]

In the above-mentioned embodiment, the drive cone portion 9d is formed into the paracurved shape. Instead, in the present invention, the drive cone portion 9d maybe formed into the straight shape.

In addition, in the above-mentioned embodiment, the cap 11 formed into the curve shape projecting on the side of the voice coil bobbin 7 is applied to the speaker device 100. However, the present invention is not limited to this. In the present invention, a cap formed into the curve shape projecting on the side opposite to the voice coil bobbin 7, i.e., on the sound output side, may be applied to the speaker device 100. By such a structure, the above-mentioned operation and effect of the present invention can be obtained.

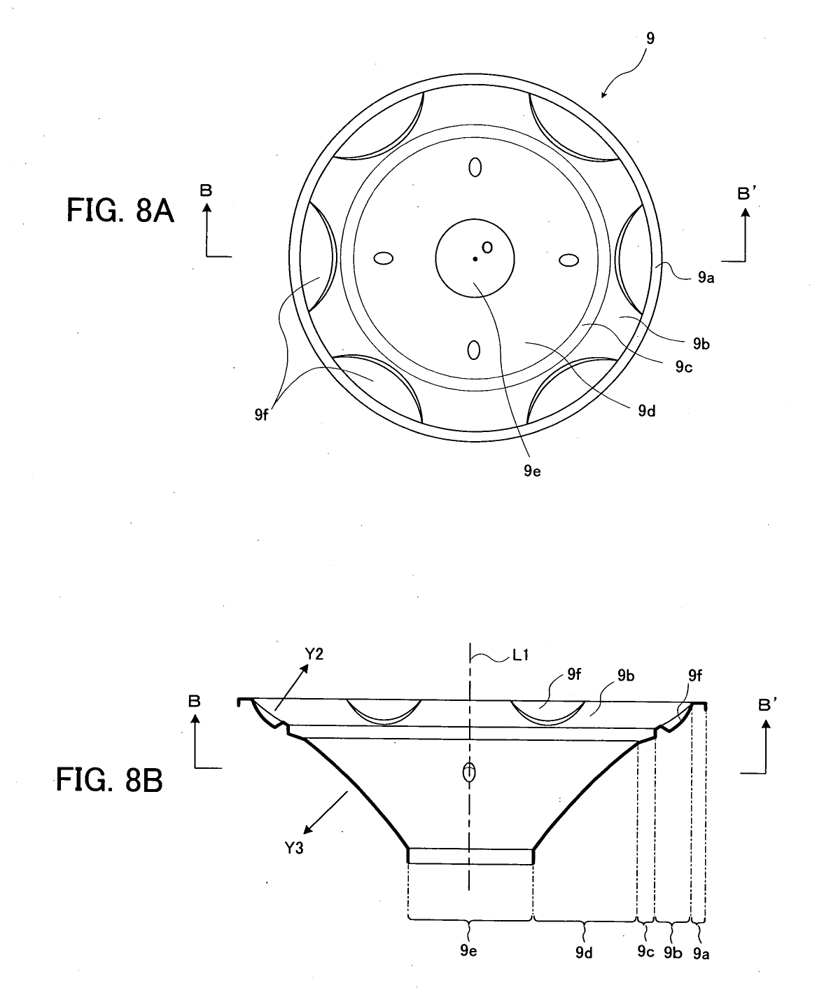

Furthermore, in the present invention, plural recessed portions may be formed on the main cone portion 9b. Thereby, the strength of the diaphragm 9 can be improved. FIG. 8A shows a plan view of the diaphragm 9 having the main cone portion 9b on which plural recessed portions are formed. FIG. 8B shows a cross-sectional view of the diaphragm 9 taken along the cut line B-B′ shown in FIG. 8A. It is noted that FIGS. 8A and 8B correspond to FIGS. 2A and 2B, respectively. As shown in FIGS. 8A and 8B, plural recessed portions 9f are formed on the upper surface of the main cone portion 9b of the diaphragm 9 along the circumferential direction with an appropriate space therebetween. Additionally, instead of such a plural recessed portions 9f, plural projecting portions (not shown) may be formed on the upper surface of the main cone portion 9b. Thereby, the strength of the diaphragm 9 can be also improved.

The invention may be embodied on other specific forms without departing from the spirit or essential characteristics thereof. The present embodiments therefore to be considered in all respects as illustrative and not restrictive, the scope of the invention being indicated by the appended claims rather than by the foregoing description and all changes which come within the meaning an range of equivalency of the claims are therefore intended to embraced therein.

The entire disclosure of Japanese Patent Application No. 2004-314110 filed on Oct. 28, 2004 including the specification, claims, drawings and summary is incorporated herein by reference in its entirety.

What is claimed is:

1. A diaphragm for a speaker device comprising:
a drive diaphragm portion which is bonded to a voice coil bobbin;
a main diaphragm portion which is provided at an outer circumference of the drive diaphragm portion; and
a cap which has an outer peripheral edge portion fixed to a substantial border portion of the drive diaphragm portion and the main diaphragm portion.

2. The diaphragm for the speaker device according to claim 1, wherein a cross-section of the drive diaphragm portion is formed into a curve shape having a center on a side opposite to a sound output side with respect to the drive diaphragm portion.

3. The diaphragm for the speaker device according to claim 1, wherein a cross-section of the drive diaphragm portion is formed into a straight shape.

4. The diaphragm for the speaker device according to claim 1, wherein a cross-section of the main diaphragm portion is formed into a parabolic shape.

5. The diaphragm for the speaker device according to claim 4, wherein the cross-section of the main diaphragm portion is formed into a curve shape having a center on a side of a sound output side of the drive diaphragm portion.

6. The diaphragm for the speaker device according to claim 1, wherein plural recessed portions or projecting portions are formed on the main diaphragm portion.

7. A speaker device having a diaphragm comprising:
a drive diaphragm portion which is bonded to a voice coil bobbin;
a main diaphragm portion which is provided at an outer circumference of the drive diaphragm portion; and
a cap which has an outer peripheral edge portion fixed to a substantial border portion of the drive diaphragm portion and the main diaphragm portion.
